(19) United States
(12) Patent Application Publication
(10) Pub. No.: US 2013/0325532 A1
(43) Pub. Date: Dec. 5, 2013

(54) METRICS BASED ON CONTENT USAGE OF SALES PLAYBOOKS

(71) Applicants: Karen P. Meyer, Nashua, NH (US); Deirdre Sommerkamp, Derry, NH (US); Leo P. Steffens, Bedford, NH (US)

(72) Inventors: Karen P. Meyer, Nashua, NH (US); Deirdre Sommerkamp, Derry, NH (US); Leo P. Steffens, Bedford, NH (US)

(73) Assignee: QVIDIAN, INC., Lowell, MA (US)

(21) Appl. No.: 13/486,306

(22) Filed: Jun. 1, 2012

(51) Int. Cl. G06Q 10/00

(52) U.S. Cl. 705/7.11

(57) ABSTRACT

By combining information from a CRM system about changes in status of entities, such as customers, leads, and the like, with information about usage of a sales playbook and content related to such playbook usage, metrics describing the effectiveness of content can be determined.

### BACKGROUND

For sophisticated sales processes, companies generally maintain computer systems that track substantial amounts of information about customers and potential customers. Such computer systems are commonly referred to as customer relationship management (CRM) systems.

Another tool that is commonly used in sophisticated sales processes is a sales playbook. A sales playbook defines a sequence of steps to be performed by a user, such as sales personnel, marketing personnel, customer support personnel and other users in an organization, when engaging a prospect or customer. A sales playbook can be implemented on a computer, herein called a computerized sales playbook system, and includes several playbook elements, each of which includes instructions, content, and the like to be used in the step of engaging a prospect or customer.

While some computerized sales playbook systems have access to data in a customer relationship management system, the data in the two computer systems generally are maintained through separate processes. In other words, one or more users update data in the CRM system, and separately one or more users update data in the computerized sales playbook system.

The steps of the sales process often are situational, in that they depend on the status of the prospect or customer in the sales process. This situational nature can be expressed by a set of rules or conditions that determine, based on data about a prospect or customer such as from a CRM system, whether a playbook, or action within a playbook, or specific content in the playbook, is provided to a user.

### SUMMARY

By combining information from a CRM system about changes in status of entities, such as customers, leads, and the like, with information about usage of a sales playbook and content related to such playbook usage, metrics describing the effectiveness of content can be determined.

For example, the CRM system may include information regarding sales outcomes, e.g., a deal was closed or lost, related to sales prospect or customer. Any change in this status can be related in time to actions taken by a user through a sales playbook, and content associated with those actions. This information can be processed to identify content related to successfully closed deals, and content related to lost deals, and the effectiveness of the content in helping to close a deal.

### BRIEF DESCRIPTION OF THE DRAWINGS

FIG. 1 is a block diagram of a computer system providing analytics for a computerized sales playbook system and a customer relationship management system.

FIG. 2 is an illustration of a data structure.

FIG. 3 is an illustration of a data structure.

FIG. 4 is a flow chart describing an example operation of an analysis module.

FIG. 5 is a flow chart describing an example operation of an analysis module.

FIG. 6 is a block diagram of a distributed, remote access computer system supporting such a computerized sales playbook system.

### DETAILED DESCRIPTION

The following section describes an example implementation of a computerized sales playbook system.

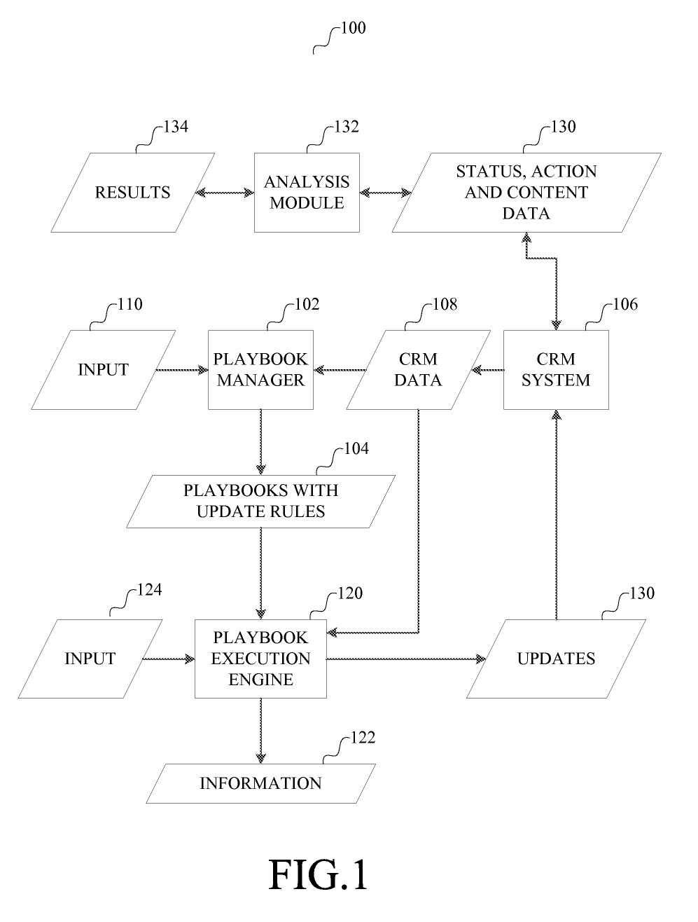

Referring to FIG. 1, a computerized sales playbook system 100 includes a playbook manager 102 through which an individual can create sales playbooks 104, by providing user input 110. The sales playbook includes a plurality of playbook elements. A playbook includes instructions, content, and the like to be used in a step in a process of engaging a prospect or customer. Various rules can be associated with playbook elements to determine which playbooks, plays, content and other playbook elements to make available to the users. One or more of the playbook elements can have an associated update rule.

The content in sales playbooks can be a variety of media types, including but not limited to text, spreadsheets, presentations, audio, video and other electronic media types that can be communicated to a prospect or customer.

The sales playbooks are stored in computer readable storage. For example, playbooks, rules and the relationship between rules and playbooks can be stored as rows in a relational database. For example, one table can include rows that relate playbook elements with rules. Another table can include rows defining the playbook elements in a playbook, and the content used in each element. Another table can include rows defining elements of the rules. A variety of other implementations can be used to define playbooks, rules and their interrelationships and the invention is not limited to a specific implementation of such.

A customer relationship management (CRM) system 106 provides CRM data 108 to the playbook manager 102.

In the playbook manager, through user input 110, update rules can be defined and associated with a playbook element, such as a playbook, play or stage. In defining an update rule, available CRM data 108 from a CRM system 106 can be identified, to allow a user to specify which fields in the CRM system should be updated. By reading the available CRM fields at runtime, the system is able to support standard CRM fields and any custom fields that have been configured in the CRM system.

A playbook execution engine 120 receives and processes sales playbooks 104 to provide information 122 to users from the sales playbook. The engine 120 has an input for receiving a sales playbook from computer readable storage. It also has an output that presents playbook elements from the sales playbook to a user, such as by providing the data to a display or to another computer. For example, data defining a sales playbook can be read from a database, and such data can be used to generate a document in a markup language, such as the eXtensible Markup Language (XML), which in turn can be sent to an application that renders the document for display.

The playbook engine also configured to receive input 124 from the user indicative of the user completing a playbook element. The inputs can come from input devices connected to a computer that supports the playbook execution engine, or from a remote computer or device used by the user. The playbook execution system also has access to CRM data 108 from a CRM system 106.

When accessing sales playbooks, various rules associated with playbook elements determine which playbooks, plays, content and other playbook elements to make available to the users. In addition, as noted above, a playbook element may be configured to have one or more associated update rules which determine what occurs when a playbook element is completed.

Upon determining that a playbook element has been completed, any configured update rules for the playbook element are invoked to send updates 130 the CRM system. The completion of a playbook element can be detected either automatically or in response to user input 124. For example, a playbook stage is completed when all of the plays in the stage have been completed.

Update rules, and/or other organizational processes, cause data to be stored in the CRM system 106 about the actions taken by users with respect to sales playbook stage, plays and other playbook elements, and the content associated with these playbook elements. Similarly, update rules and/or other organizational processes cause changes to be entered in the CRM system. For example, information regarding sales outcomes related to a sales prospect or customer can be stored, such as whether a deal has been closed and an amount of revenue associated with the deal. These changes in status can be correlated with actions from a playbook in a number of ways, for example, by proximity in time.

Data 130 from the CRM system that describes the actions in the playbook, changes in status and content associated with actions in the playbook can be provided to an analytic module 132. The analytic module analyzes the data to provide results 134 indicative of the effectiveness of the content in selling to the sales prospects or customers. There are a variety of ways of performing such analytics, some examples of which are described in more detail below.

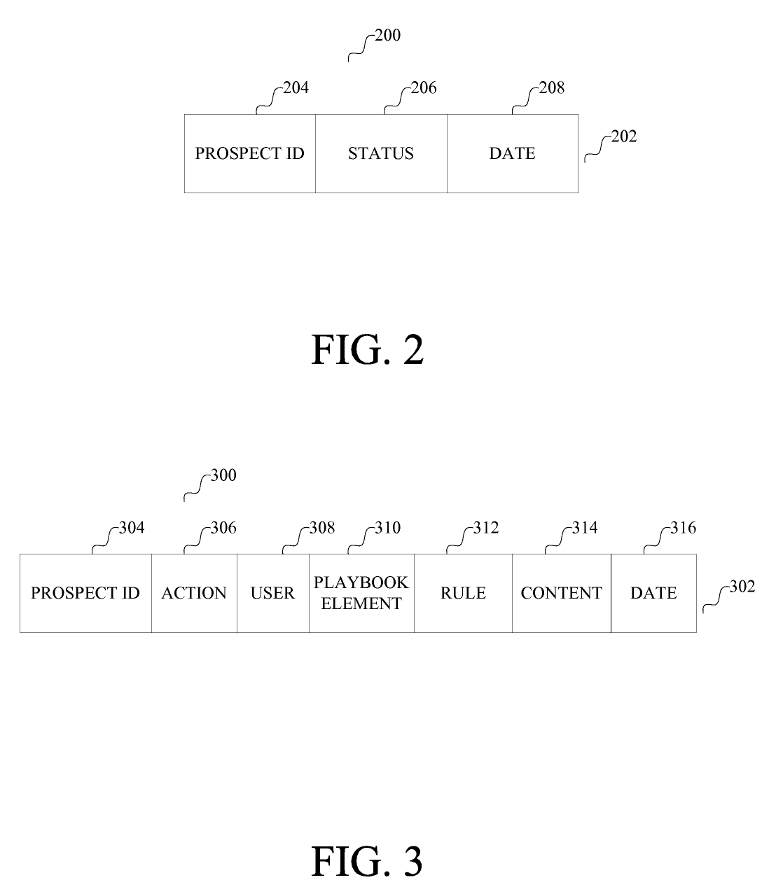

Given this context, an example implementation of such a system, with particular emphasis on the analytics module, will be described in more detail in connection with FIGS. 2 through 6.

FIGS. 2 and 3 describe example data table for a database that stores information relating CRM status, playbook actions and playbook content.

FIG. 2 illustrates a table 200, in abbreviated format, of data from a CRM system regarding a sales prospect or customer. Each row 202 contains an identifier 204 for the prospect or customer, a status field 206 and a date 208. Other information related to the sales process could be stored in additional fields (not shown), including but not limited to a revenue (or potential revenue) amount related to a potential transaction with the prospect or customer.

FIG. 3 illustrates a table 300, in abbreviated format, of data that can be stored, whether in the CRM system or elsewhere, about the sales playbook usage and related content. The table includes a plurality of rows 302, each of which relates various sales playbook information with a sales prospect or customer, identified by the identifier 304 for the prospect or customer. The identifiers 304 and 204 come from the same data set, thus allowing the CRM data to be related to the sales playbook data.

The data about the sales playbook usage and related content can be provided in a variety of formats. As one example, such information can include data that identifies an action 306, a user 308 (who performed the action), a playbook element 310 (used in the action), any rule 312 associated with the playbook element, content 314 used in the playbook element 310, and a date 316.

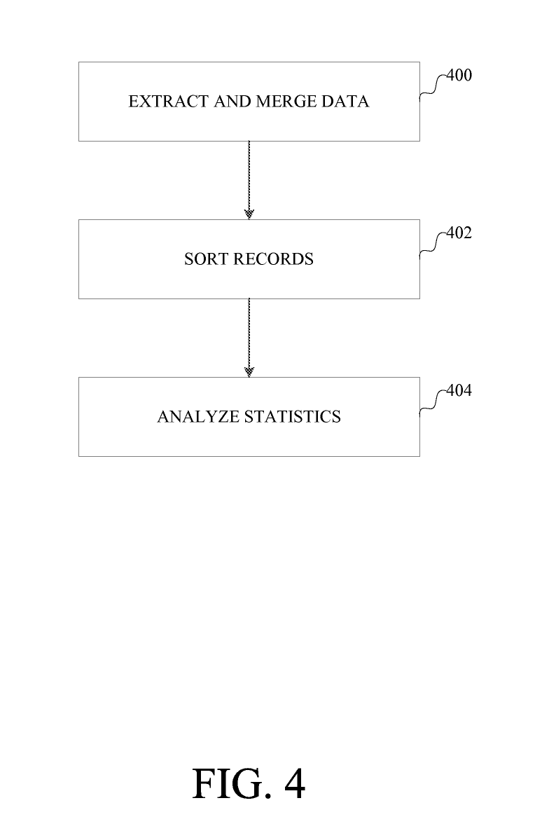

Given such data stored in a database, a variety of analytics operations can be performed to analyze the effectiveness of content, and/or other sales playbook related information. The analytic process is generally described by FIG. 4. First, data is extracted 400 from the database and transformed into a format that simplifies processing. For example, data from the various tables in the database can be extracted and transformed into a single array addressed by one of the fields in the array. Next, the data is sorted 402 or otherwise segmented (by multiple levels of sorting for example). The result of such sorting is to provide groups of data that have similar characteristics, from which statistical information about that group, or for that group in relation to other groups, can be determined. The statistics of the data is then analyzed 404.

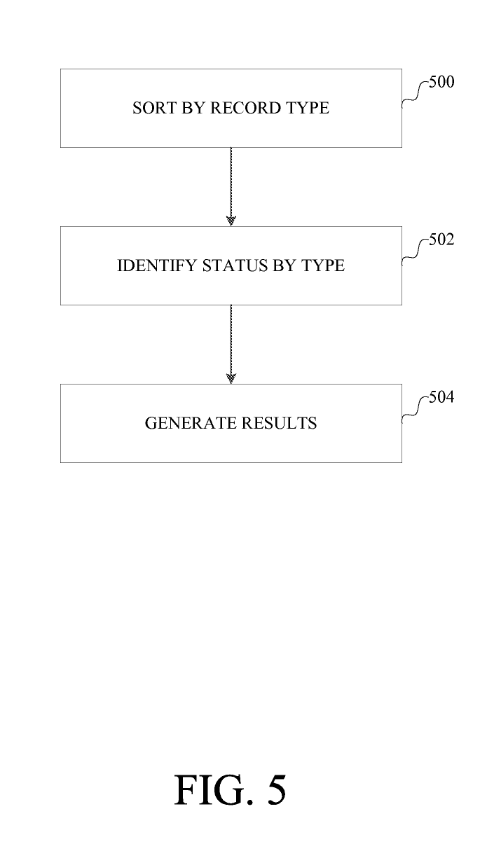

A more detailed example is shown in FIG. 5. The data can be sorted 500 by a specific field, such as a prospect or customer identifier, prospect or customer status, sales playbook (or playbook element) identifier, content identifier, user identifier, rule identifier, or the like, depending on the analysis results desired. Given the sorted data, the status of sales prospect or customers within each group of sorted data can be identified 502. For example, for each content identifier, the numbers of closed, successful sales, open prospect or customers, and lost sales can be identified, along with associated revenue (or potential or lost revenue) can be obtained. Results can then be computed 504 and provided to a user. For example, one could determine that success rate for each item of content.

A variety of other analyses could be performed. For example, on sales opportunities that have been won, one can determine which content contained within each play was used to win that opportunity. In this example, the records of all sales opportunities that have been won during a period of time are identified from the database. Next, the content used in each of those opportunities is identified from the database.

As another example, for a given play that is executed in multiple opportunities, one can determine which content is being used and which content is not being used. In this example, records of opportunities are sorted or filtered by a play identifier. From these records, the content identifiers stored in the database indicate which content was used with those opportunities. Given a play identifier, one can determine from the playbook which content is included in the play but not used.

As a third example, one can determine overall which content is being used and how many times by an entire sales organization as associated with their sales opportunities and all plays used in all playbooks. For example, the database records can be sorted by content identifier, and the number of records using a content identifier indicates the number of times that content has been used. Those records can be further sorted or filtered on other fields to determine the sales opportunities in which they were used, the outcomes of those sales opportunities, the playbooks in which they reside, etc.

As a fourth example, one can determine which content has been used in each stage of the selling cycle, which content the user has added to the play that the playbook manager did not prescribe, which content an expert contributed that helped to close the deal, which content was liked by the users, and which content is disliked by the users.

As a fifth example, one can determine the overall effectiveness of the playbook rules that drive the play and the content that is shown in each play when correlated with the win or loss information associated with a deal.

In a sixth example, the records of all opportunities won or lost in a certain period of time can be determined and compared against the use of customer or buyer utilized content for each play. An organization can then use this information to draw conclusions about the value of content to its buyers.

In a seventh example, one can determine which content is being used versus not used overall across all systems in which content utilized in playbooks is being stored and, therefore, validate the investment the organization is making in the use of those systems.

In an eighth example, one can determine the amount of time taken to complete plays, stages, and playbooks, that contain content that is used for won or lost deals. This measurement can be determined across an entire book of business or segment of deals for an organization. This measurement also can indicate stall points or slowdowns in a sales cycle.

Having now described an example implementation of an analytical module, a computing environment for supporting such a system will now be described. Such a computing environment can include numerous general purpose or special purpose computing hardware configurations. Examples of well known computing devices, which can be microprocessor-based systems or multiprocessor systems for example, include, but are not limited to, personal computers, server computers, hand-held computing devices (for example, media players, cellular phones, personal data assistants, voice recorders), laptop computers, notebook computers, set top boxes, game consoles, programmable consumer electronics, network computers, minicomputers, mainframe computers, distributed computing environments that include any of the above devices, and the like.

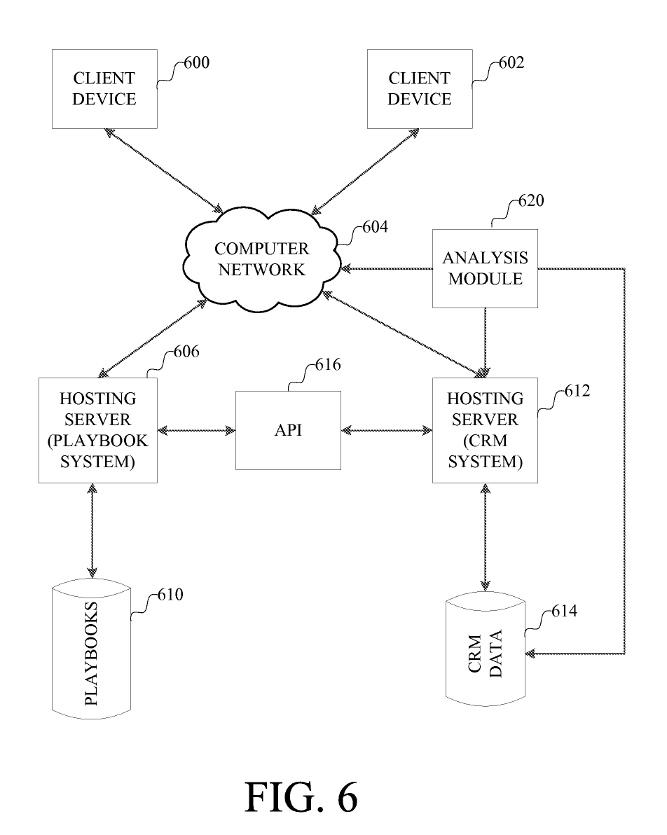

FIG. 6 illustrates an example of a networked computing system environment for implementing such a system. This is only one example of such an implementation. Other implementations are possible. The system also can be implemented using computing environments that are not distributed, such as a single computing machine.

In FIG. 6, client devices 600 and 602 connect to a computer network 604, such as the internet. A client device can be a typical personal computer, laptop computer, notebook computer, tablet device, mobile phone or smartphone, with a variety of possible input devices and output devices.

A hosting server 606 for the computerized playbook system is connected to the computer network 604. The hosting server accesses a database 608 that stores playbook data, including playbooks and rules, including selection rules and update rules. A user accesses the hosting server through a host application (not shown), such as an internet browser, running on the client device. After logging in by providing appropriate credentials, a user is provided various interfaces by the hosting server for accessing the sales playbook system, such as the interfaces described above.

Similarly, a hosting server 612 for a customer relationship management (CRM) system is connected to the computer network 604. This hosting server accesses a database 614 that stores CRM data. A user also accesses this hosting server through a host application (not shown), such as an internet browser, running on the client device. An application programming interface (API) 616 can connect the hosting server for playbook system to the hosting server for the CRM system. This API can be used to log into the CRM system, and also can be used (as described above) to allow the playbook system to access CRM data for use in the sales playbook system, such as for creating content, defining rules and the like.

An analytics module 620 can access the CRM data in a variety of ways. The module can access the data through the CRM system hosting server 612. The module can access the data directly from the database 614. The module also can access either of these remotely through the computer network 604. In some cases, the CRM system or the database system can be used to extract data sets, which are then transmitted over computer network 604 to an analytics module.

An example computing machine that can be used in such a networked environment to implement all or part of this sales playbook system will now be described. A computing machine typically includes at least one processing unit and memory. The computing machine may include multiple processing units and/or additional co-processing units, such as a graphics processing unit (GPU). Memory may be volatile (such as RAM), non-volatile (such as ROM, flash memory, etc.) or some combination of the two. A computing machine may include persistent storage, which can be removable or non-removable, example of which include, but are not limited to, magnetic or optical disks or tape.

Computer storage media includes volatile and nonvolatile, removable and non-removable media implemented in any method or technology for storage of information such as computer program instructions, data structures, program modules or other data. Memory removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine. Any such computer storage media may be part of computing machine.

A computing machine also may have communications connection(s) that allow the computing machine to communicate with other devices over communication media. Communication media typically transmits computer program instructions, data structures, program modules or other data between storage in one device to storage in another device. By way of example, and not limitation, communication media includes wired media such as a wired network or direct-wired connection, and wireless media such as acoustic, RF, infrared and other wireless media.

A computing machine also has input devices. Example input devices include but are not limited to, a keyboard, mouse, a touch input device, camera, and so on. A computing machine also has output device. Example output devices include, but are not limited to, a display, speakers, a printer, and so on. Such devices are well known in the art and are therefore not discussed at length here.

The sales playbook system is generally implemented in such an environment using computer programs, which include computer-executable instructions and/or computer-interpreted instructions, such as program modules, being processed by a computing machine. Generally, program modules include routines, programs, objects, components, data structures, and so on, that, when processed by a processing unit, instruct the processing unit to manipulate data in memory to implement data structures, or to process data into another form or representation according to defined operations. Such instructions generally are stored in and read from computer readable storage media by a processing unit.

It should be understood that the subject matter defined in the appended claims is not limited to the specific implementations described above. The specific implementations described above are presented as examples only.

What is claimed is:

1. A computer system comprising:
a sales playbook engine;
a customer relationship management system having data relating to a plurality of sales prospects or customers and information regarding sales outcomes related to each sales prospect or customer;
wherein the CRM system further stores data generated by the sales playbook engine indicating actions taken by users with respect to playbook elements, and changes in status of sales prospects or customers related to such actions, and content related to such actions; and
an analytic module having inputs for receiving data regarding the actions, changes in status and content and outputs providing data indicative of the effectiveness of the content in selling to the sales prospects or customers.

2. The computer system of claim 1, wherein the analytic module aggregates and sorts data relating to actions, content and status, and sorts the aggregated data, to identify statistically significant differences among groups of the data.

3. The computer system of claim 1, wherein the data is sorted by a type of the data.

4. The computer system of claim 3, wherein the sorted data is segmented to identify segments primarily related to success of engagements.

5. The computer system of claim 3, wherein the sorted data is examined to compare the relative success of engagements between a first instance of the type of data and a second instance of the type of data.

6. The computer system of claim 3, wherein type of data is one of a user identifier, content identifier, playbook element identifier, rule identifier and status identifier.

7. An article of manufacture comprising:
a computer-readable storage medium;
computer program instructions stored on the computer-readable storage medium that, when processed by a computer, configures the computer as a computer system comprising:
a sales playbook engine;
a customer relationship management system having data relating to a plurality of sales prospects or customers and information regarding sales outcomes related to each sales prospect or customer;
wherein the CRM system further stores data generated by the sales playbook engine indicating actions taken by users with respect to playbook elements , and changes in status of sales prospects or customers related to such actions, and content related to such actions; and
an analytic module having inputs for receiving data regarding the actions, changes in status and content and outputs providing data indicative of the effectiveness of the content in selling to the sales prospects or customers.

8. The article of manufacture of claim 7, wherein the analytic module aggregates and sorts data relating to actions, content and status, and sorts the aggregated data, to identify statistically significant differences among groups of the data.

9. The article of manufacture of claim 7, wherein the data is sorted by a type of the data.

10. The article of manufacture of claim 7, wherein the sorted data is segmented to identify segments primarily related to success of engagements.

11. The article of manufacture of claim 7, wherein the sorted data is examined to compare the relative success of engagements between a first instance of the type of data and a second instance of the type of data.

12. The article of manufacture of claim 7, wherein type of data is one of a user identifier, content identifier, playbook element identifier, rule identifier and status identifier.

13. A computer-implemented process comprising:
storing, in a customer relationship management system, data generated by a sales playbook engine indicating actions taken by users with respect to playbook elements,
storing data generated by a sales playbook engine indicating changes in status of sales prospects or customers related to such actions, and content related to such actions
analyzing the stored data regarding the actions, changes in status and content to provide data indicative of the effectiveness of the content in selling to the sales prospects or customers.

14. The computer implemented process of claim 13, wherein analyzing comprises aggregating data relating to actions, content and status, and sorting the aggregated data to identify statistically significant differences among groups of the data.

15. The computer implemented process of claim 14, wherein the data is sorted by a type of the data.

16. The computer implemented process of claim 14, wherein the sorted data is segmented to identify segments primarily related to success of engagements.

17. The computer implemented process of claim 14, wherein the sorted data is examined to compare the relative success of engagements between a first instance of the type of data and a second instance of the type of data.

18. The computer implemented process of claim 14, wherein type of data is one of a user identifier, content identifier, playbook element identifier, rule identifier and status identifier.
